(19) United States
(12) Patent Application Publication
(10) Pub. No.: US 2008/0303366 A1
(43) Pub. Date: Dec. 11, 2008

(54) Electric fan and casing thereof

(75) Inventor: Michael Chen, Taipei Hsien (TW)

Correspondence Address: Joe McKinney Muncy, PO Box 1364, Fairfax, VA, 22038-1364, US

(73) Assignee: TOPOWER COMPUTER INDUSTRIAL CO., LTD.

(21) Appl. No.: 11/808,198

(22) Filed: Jun. 7, 2007

(51) Int. Cl. H02K 5/22

(52) U.S. Cl. 310/90

(57) ABSTRACT

The present invention discloses an electric fan and a casing thereof, wherein the casing wall can be arbitrarily detached to from an air flow inlet. The four corner elements of the casing define an assembly space where the electric fan is accommodated. First fixing members and second fixing members matching each other are respectively formed in the corner elements and the casing walls; the first and second fixing members can thus be assembled together or separated apart. Thereby, an electric fan casing having detachable casing walls is thus achieved.

### FIELD OF THE INVENTION

The present invention relates to an electric fan and a casing thereof, particularly to an electric fan and a casing thereof, wherein a casing wall can be arbitrarily detached to create an air flow inlet meeting the usage environment.

### BACKGROUND OF THE INVENTION

Generally to speak, a computer or another electronic device has various elements and circuits, such as CPU, power supplies, and circuit boards. When a computer or electronic device operates, current flowing through chips or circuits generates a lot of heat. Thus, an electric fan is needed to inhale cool air to dissipate heat lest accumulated heat raise temperature and damage elements or circuits, which will causes the computer or electronic devices to malfunction or shortens the service life thereof.

Most conventional heat-dissipation electric fans inhale and exhale unidirectionally, which usually cannot dissipate the heat accumulating in local regions inside the housing of an electronic device. To solve such a problem, most manufacturers pay attention to raise fan blade rotation speed and improve fan blade structure to increase air input of an electric fan. However, the wind-shear induced noise increases with the rotation speed of an electric fan. Besides, the effect of improving fan blade structure is very limited. Therefore, raising fan blade rotation speed and improving fan blade structure cannot really solve the problem that heat accumulates in local regions inside the housing of an electronic device.

A R.O.C. Patent No. M287881 disclosed an “Electric Fan Frame”, which comprises a plurality of guide vanes, wherein the guide vanes connects with each other via at least one rib strips. The guide vanes are not arranged concentrically but along curves. The guide vanes define an opening where a fan is installed, and the fan comprises a plurality of fan blades. Via the shape and arrangement of the guide vanes, the air input and output of the electric fan is obviously increased. Another R.O.C. publication No. 535859 also disclosed an “Electric Fan Frame”, wherein the electric fan frame has an opening, and air inlets are formed in the laterals of the electric fan frame, including the holes formed in the surfaces and recesses of the laterals of the electric fan frame and the auxiliary air inlets formed inside the recesses and radially open to the perimeter of the electric fan arranged in the opening. When the electric fan operates, air can enter from the opening, the holes and the auxiliary inlets. Thus, the air intake area increases, and air output rises. Although the abovementioned conventional technologies can increase air input and raise air output to some extent, they still have problems. The spacing of the guide vanes or the air inlets is too small to effectively increase air input and is apt to create wind resistance and wind-shear noise. Therefore, the abovementioned conventional technologies are hard to effectively dissipate heat of electronic devices and meet consumers' need.

### SUMMARY OF THE INVENTION

The primary objective of the present invention is to provide an electric fan and a casing thereof to solve the abovementioned problems, wherein a casing wall can be arbitrarily detached to create an air flow inlet meeting the usage environment to effectively increase air input and air output of the electric fan and reduce heat locally accumulating in electronic devices.

Another objective of the present invention is to reduce noise generated by wind shear, wherein a casing wall is detached to reduce air suction resistance and effectively decrease wind-shear noise to achieve a quiescent state.

The present invention thus proposes an electric fan and a casing thereof, which has detachable casing walls, wherein the four corner elements of a casing define an assembly space where an electric fan is accommodated; first fixing members and second fixing members are respectively formed in corner elements and casing walls; the first and second fixing members can thus be assembled together or separated apart.

### BRIEF DESCRIPTION OF THE DRAWINGS

FIG. 1 is a perspective view schematically showing the appearance of an electric fan and a casing thereof according to the present invention.

FIG. 2 is an exploded view schematically showing the structure of an electric fan and a casing thereof according to the present invention.

FIG. 3 is a sectional view schematically showing the assembled structure of an electric fan and a casing thereof according to the present invention.

FIG. 4 is a diagram schematically showing the air flow in an electric fan and a casing thereof according to the present invention.

FIG. 5 is a diagram schematically showing a different type casing wall according to another embodiment of the present invention.

FIG. 6 is a diagram schematically showing the integration of the casing walls and the corner elements according to further another embodiment of the present invention.

### DETAILED DESCRIPTION OF THE PREFERRED EMBODIMENTS

Below, the technical contents of the present invention will be described in detail in cooperation with the drawings.

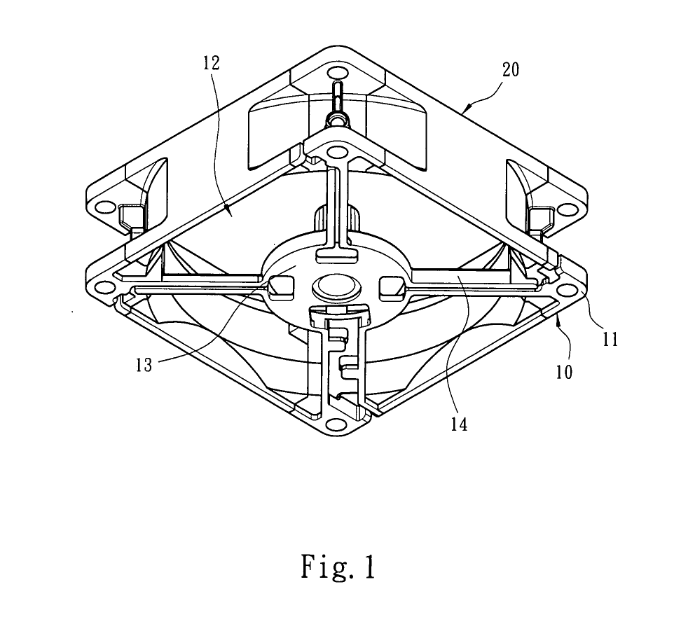

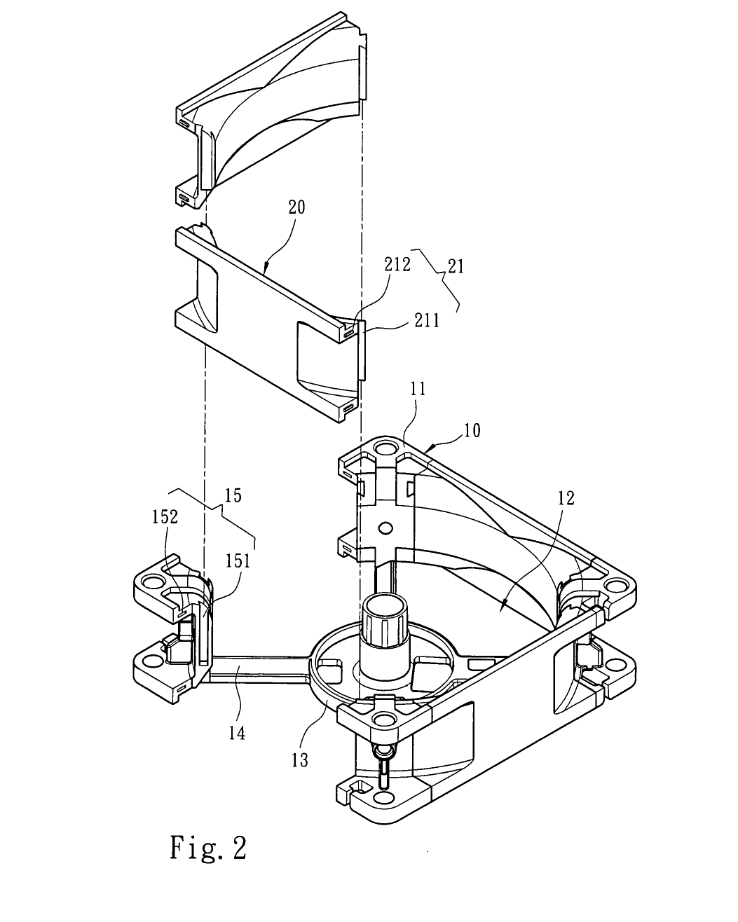

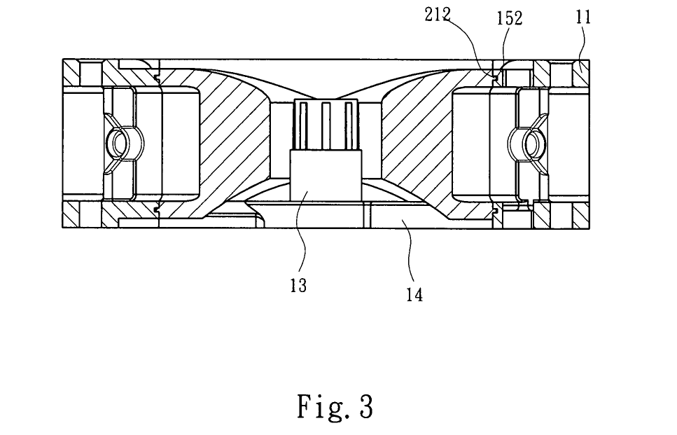

Refer to from FIG. 1 to FIG. 3 respectively a perspective view, an exploded view and a sectional view schematically showing an electric fan and a casing thereof according to the present invention. The present invention comprises: a casing 10, an electric fan 13, and at least one casing wall 20. The casing 10 has four corner elements 11 defining an assembly space 12. The electric fan 13 is accommodated in the assembly space 12 and has a motor seat and fan blades (not shown in the drawing). The electric fan 13 is supported in the assembly space by a plurality of rib strips 14 connecting the electric fan 13 with the corner elements 11. The casing walls 20 are respectively arranged in between each two corner elements 11. The casing 10 has first fixing members 15, and the casing walls 20 have second fixing members 21 corresponding to the first fixing members 15. In the embodiment shown in the drawings, the first fixing member 15 includes a slide way 151, and the second fixing member 21 includes a slide track 211 matching the slide way 151. However, the present invention does not limit the first fixing member 15 and the second fixing member 21 to be a slide way 151 and a slide track 211. The first/second fixing member 15/21 further comprises a convex/concave member 212/152. When assembled, the convex and concave members 212 and 152 form a position-limiting relationship. Thereby, the first and second fixing members 15 and 21 can be assembled together or separated apart. Thus, the electric fan 13 and the casing 10 thereof having the detachable casing walls 20 are attained.

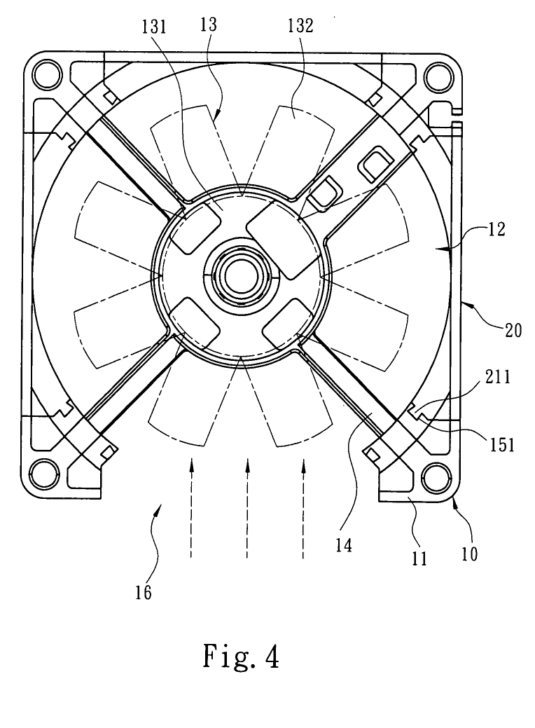

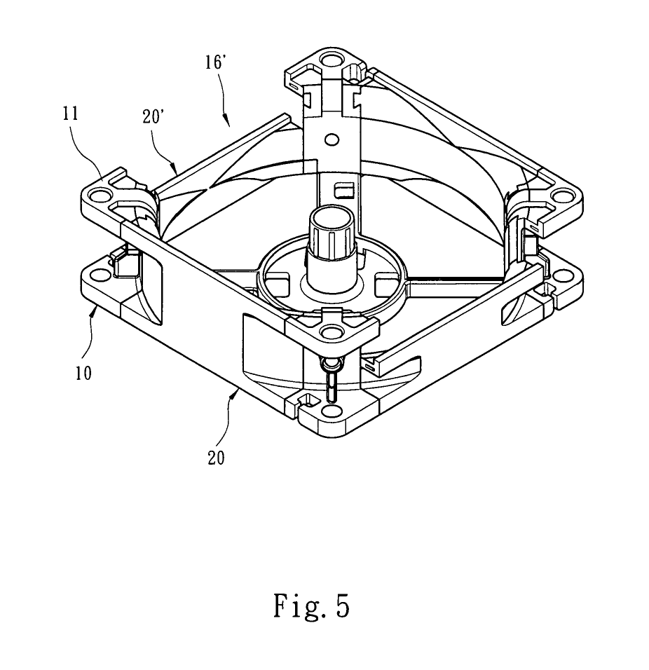

In one embodiment of the present invention, each two corner elements 11 has one casing wall 20 therebetween, and the casing wall 20 is engaged with the corner element 11 via the slide track 211 of the second fixing member 21 and the slide way 151 of the first fixing member 15. When the slide track 211 is completely placed inside the slide way 151, the convex member 212 is also press-fit into the concave member 152 to perform a position-limiting function. Refer to FIG. 4. The casing wall 20 can be removed via disengaging the first fixing member 15 from the second fixing member 21. After the casing wall 20 is removed, the original position forms an air flow inlet 16. Therefore, when the electric fan 13 and the casing 10 thereof is used to dissipate heat, such as used in CPU of a computer or a power supply, air suction will not retarded by a barrier, such as the housing of a power supply. Then, fan blades 132 on a motor seat 131 can operate normally. Refer to FIG. 5. As the present invention adopts a detachable design of casing walls 20, the casing wall 20 can be replaced by a casing wall 20′ having a height less than that of the corner element 11 if necessary. Thus, a casing wall 20′ is still maintained in between two corner elements 11, and an air flow inlet 16′ is still maintained above the casing wall 20′.

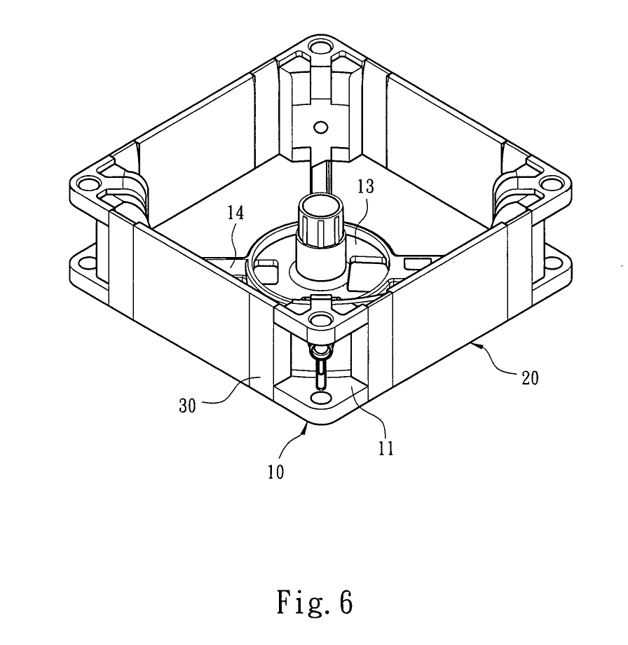

Refer to FIG. 6. In addition to the detachable casing wall 20 and the replaceable different-height casing wall 20′ described in the abovementioned embodiments, the present invention also comprises a one-time detachable casing wall 20 in another embodiment; once the casing wall 20 is detached, it can not be recovered any more. In this embodiment, the first and second fixing members 15 and 21 are integrated into a connection member 30. In the manufacturing process, the casing 10, the casing walls 20 and the connection members 30 are fabricated into a one-piece part by an injection molding technology. When the usage environment requires an air flow inlet (not shown in the drawing), the casing wall 20 can be removed from the casing 10 via applying force to break the connection members 30. In a preferred embodiment, the connection member 30 is fabricated to have a thickness and a width less than those of the casing wall 20 to facilitate separating them with force.

Those described above are only the preferred embodiments to exemplify the present invention but not to limit the scope of the present invention. Any equivalent modification or variation according to the spirit of the present invention is to be also included within the scope of the present invention.

What is claimed is:

1. An electric fan and a casing thereof comprising:
a casing having four corner elements to define an assembly space;
an electric fan accommodated in said assembly space;
at least one casing wall arranged in between each two corner elements,
wherein said casing has first fixing members at said corner elements, and said casing walls have second fixing members corresponding to said first fixing members; said first fixing member and said second fixing member can be assembled together or separated apart to realize an electric fan and a casing thereof having detachable casing walls.

2. The electric fan and the casing thereof according to claim 1, wherein said first fixing member and said second fixing member is a set of slide way and slide track matching each other.

3. The electric fan and the casing thereof according to claim 1, wherein said first fixing member and said second fixing member further comprises a set of concave member and convex member, which forms a position-limiting relationship when assembled.

4. The electric fan and the casing thereof according to claim 1, wherein said first fixing member and said second fixing member are integrated into a connection member.

5. The electric fan and the casing thereof according to claim 1, wherein said electric fan is coupled to said corner elements with a plurality of rib strips.
